(19) United States
(12) Patent Application Publication
(10) Pub. No.: US 2026/0298837 A1
(43) Pub. Date: Oct. 1, 2026

(54) METHOD AND DEVICE FOR DETERMINING A LEVEL OF CONTAMINATION OF A SURFACE

(71) Applicants: Airbus (S.A.S.), Blagnac Cedex (FR); Airbus Operations (S.A.S.), Toulouse (FR); Airbus Operations GmbH, Hamburg (DE)

(72) Inventors: Rolim Carmo, Hamburg (DE); Matthias Otto, Hamburg (DE); Wladislav Lagutin, Hamburg (DE); Boris Moriniere, Rochefort (FR); Samuel Leleu, Toulouse (FR); Olivier Bürgy, Toulouse (FR)

(73) Assignees: Airbus (S.A.S.), Blagnac (FR); Airbus Operations (S.A.S.), Toulouse (FR); Airbus Operations GmbH, Hamburg (DE)

(21) Appl. No.: 19/569,153

(22) Filed: Mar. 17, 2026

(30) Foreign Application Priority Data
Mar. 31, 2025 (FR) FR2503317

(51) Int. Cl. G01N 21/88; G01B 11/08

(52) U.S. Cl. CPC G01N 21/8851; G01B 11/08; G01N 2021/888; G01N 2021/8893; G01N 2201/13

(57) ABSTRACT

A method for determining the level of contamination of a surface, including covering all or some of a surface with drops of colorless fluid, all having substantially the same volume, the drops being deposited on the surface according to a deposition scheme that is defined depending on the distance between two successively deposited drops of colorless fluid is substantially constant and each drop of colorless fluid is spaced apart by a non-zero distance from the other drops of colorless fluid surrounding it. The method includes successive steps of acquiring an image of the surface to be analyzed, a computing step, a comparing step and a counting step in order to obtain the position of the drops for which the surface under the drops is said to be contaminated.

### TECHNICAL FIELD

The disclosure herein relates to a method for determining the level of contamination of a surface, and to a device designed to implement such a method.

### BACKGROUND

The outer surface of aircraft is painted with multiple layers of paint. It is essential to implement an operation of cleaning the surfaces to be painted before the step of applying each layer of paint. Specifically, the aim of such a cleaning operation is to remove contamination (dirt, dust, grease, etc.) that can limit the durability of the paint system and degrade the aesthetic criteria. An uncontaminated surface guarantees that a durable and uniform paint finish will be obtained.

Conventionally, in order to verify that the surface to be painted is not contaminated, the operators carry out a wettability test. During this test, water is sprayed in a sufficient quantity to form a continuous and homogeneous film on the surface to be analyzed. The surface is judged to be free of contamination if the film remains continuous.

It is also known from the prior art to use a goniometer in order to measure the value of the contact angle of the drops and to determine the surface tension. The behavior of the sprayed water will vary depending on the cleanliness of the surface: if the surface is uncontaminated, the drop of water will spread and the measured value of the contact angle of the drop of water deposited on the surface is small. In contrast, on a contaminated surface, impurities will prevent the drop of water from spreading, thus increasing the value of the contact angle of the drop deposited on the surface. This test, which is carried out discretely on selected points of the surface, can be carried out by a robot in order to automate the method.

According to another known device, a robot comprises a system for spraying water droplets by misting, the system comprising ultrasonic nozzles, an optical system comprising an image sensor and a processor for processing the information generated by the image sensor, and a central unit to ensure the operation of the robot. The processor can comprise a computer, implementing software for processing the images received by the optical system. In order to detect contaminants, the robot puts in place the following steps:
a step of wetting the surface of the part to be analyzed with the deposition of an extremely fine mist of purified water, carried out by the spraying system,
a step of acquiring the image of the surface by the optical system, allowing the diameter of the droplets present on the surface to be measured before their evaporation,
a step, implemented by the optical system, of analyzing the pattern of the droplets,
a step, implemented by the optical system, of determining the level of contamination of the surface depending on the results of the analysis.

This type of robot offers convincing results. However, there is a need to improve the exactness of the locating of the contaminated regions on the surface to be analyzed, in order to optimize the subsequent intervention of the operators tasked with cleaning the surface by hand and therefore to reduce the duration of the process.

### SUMMARY

One of the objects of the disclosure herein is to meet this need in whole or in part.

To this end, the disclosure herein relates to a method for determining the level of contamination of a surface, the method comprising the following successive steps:
covering all or some of the surface with drops of colorless fluid, all having substantially the same volume, the drops being deposited on the surface according to a deposition scheme that is defined depending on the configuration of the surface and that meets the following constraints:
the distance between two successively deposited drops of colorless fluid is substantially constant,
each drop of colorless fluid is spaced apart by a non-zero distance from the other drops of colorless fluid surrounding it,
acquiring an image of the surface to be analyzed thus covered with drops of colorless fluid,
computing, for each of the drops, a ratio between a diameter D1 and a predetermined diameter Dp of the drops, the diameter D1 being measured at the base of the drop,
comparing, for each drop, the previously computed ratio with a predetermined threshold,
counting, by the optical system, the number of drops for which the surface under the drop is said to be contaminated, and recording the position of these drops on the surface,
determining a level of contamination of the surface, the level being dependent on the number counted in the previous step and on the total number of drops deposited on the surface.

Depositing the drops of colorless fluid according to a defined deposition scheme allows exact analysis of the level of contamination of the surface.

### BRIEF DESCRIPTION OF THE DRAWINGS

The above-mentioned features of the disclosure herein, along with others, will become more clearly apparent upon reading the following description of exemplary embodiments, the description being given with reference to the appended drawings, in which:

FIG. 1 is a schematic view of the device for determining a level of contamination of a surface according to a first embodiment of the disclosure herein;

FIG. 2 is a schematic view aiming to explain a computation carried out by the device for determining a level of contamination of a surface that is shown in FIG. 1;

FIG. 3 is a flowchart representative of the steps of a method for detecting a level of contamination of a surface that is implemented by the device for determining a level of contamination of a surface that is shown in FIG. 1;

FIG. 4 is a schematic view of the device for determining a level of contamination of a surface, according to a second embodiment;

FIG. 5 is a flowchart representative of the steps of the method for detecting a level of contamination of a surface that is implemented by the device for determining a level of contamination of a surface in FIG. 4.

### DETAILED DESCRIPTION

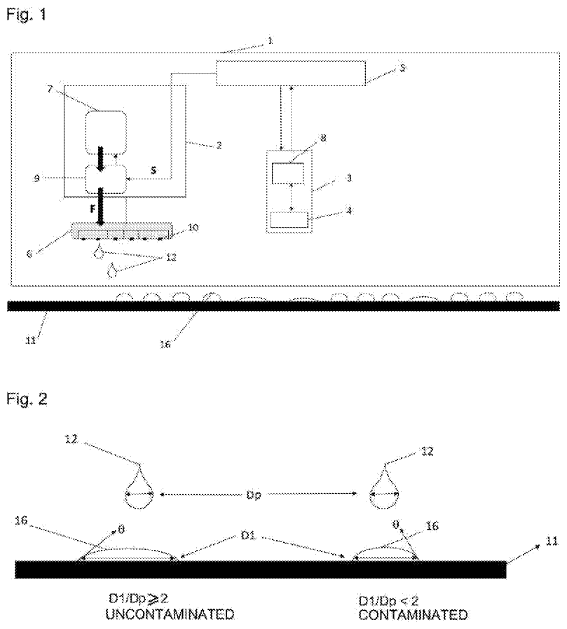

With reference to FIG. 1, a device 1 for determining a level of contamination of a surface 11 comprises:
a printing apparatus 2 and an optical system 3 for taking and analyzing an image on the surface 11, the optical system 3 comprising an image sensor 4 and image-analyzer 8, and
a central unit 5, of computer type, having a human-machine interface allowing an operator to give instructions to the device 1 for determining a level of contamination of a surface 11. The central unit 5 coordinates the interactions between the various components of the device 1 for determining the level of contamination of a surface 11, to implement the method that will be described in detail below. In particular, the central unit 5 controls the printing apparatus 2.

According to the disclosure herein, the printing apparatus 2 comprises at least one print head 6 of a first type. This print head 6 comprises a known print control system, which will not be described in greater detail.

Each print head 6 of a first type, of piezoelectric type, is equipped with a fluid cartridge 7, pumps 9, and nozzles 10, for example of the piezoelectric nozzle type, the actuation of which is controlled by the central unit 5. Each print head 6 of a first type allows, in operation, ink-jet printing.

The fluid cartridge 7 serves as a fluid reservoir. The fluid flows from the cartridge 7 to the nozzles 10 by virtue of the actuation of the pumps 9. The fluid present in the cartridge 7 is a contaminant-free solvent, which is neither acidic nor basic, in order not to damage the surface 11. The fluid is, for example, purified water.

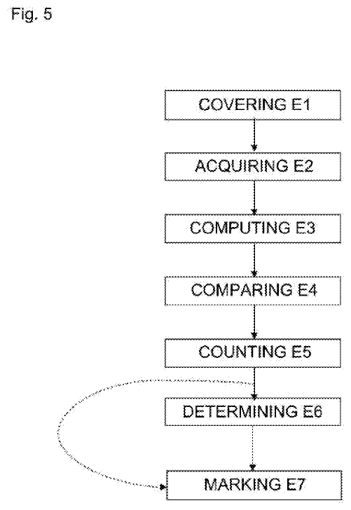

With reference to FIGS. 1 and 4, the movement of a fluid (F) is embodied by an arrow of the same type as that situated between the pumps 9 and the print head 6, for example. The signals(S) are indicated by an arrow, such as that shown between the central unit 5 and the pumps 9, for example. The arrows of signals(S) can represent control signals or information signals, for example.

The pumps 9 are controlled by the central unit 5 and, when they are activated, move the fluid from the cartridge 7 to the nozzles 10. The pumps 9 ensure a flow that is controlled by the central unit 5 with a constant pressure in the channels, avoiding flow interruptions, in order to obtain an exact spray of the drops 12. Pressure sensors are arranged between the inlet and the outlet of the print head 6 in order that the central unit 5 can act on the pumps 9 should the difference in pressure measured between the inlet and the outlet of the print head deviate from a nominal value.

Each print head 6 of a first type contains multiple nozzles 10, such as around one hundred for example. The nozzles 10 of the print heads 6 of a first type are all identical, in particular as regards the diameter of their orifice. This diameter is dimensioned such that the drops 12 leaving the nozzles 10 have a volume of between 1 and 1000 picolitres.

During the use of the device 1, the nozzles 10 are oriented to face the surface 11 to be analyzed. The configuration of the nozzles 10 is selected depending on the dimensions of the surface 11 to be analyzed.

As is known, each drop of colorless fluid 12 deposited on the surface 11 has different interaction properties depending on the cleanliness of the surface 11: on an uncontaminated surface 11, the drop 12 spreads upon contact with the surface 11 and the resulting drop 16 has a large diameter. In this situation, the value of the contact angle of the analyzed drop 16 is small. In contrast, upon contact with a contaminated surface, the drop 12 does not spread and the resulting drop 16 has a small diameter. In this situation, the value of the contact angle of the analyzed drop 16 is high.

The optical system 3 comprises an image sensor 4 and image-analyzer 8, of computer type, and the optical system 3 implements software for processing the images received from the image sensor 4. The software allows the diameter D1 of the drops 16 obtained to be measured by carrying out this measurement at their base after their deposition on a surface 11.

The image sensor 4 captures images of the surface 11 in real time, the images being synchronized with the movement of the print heads 6 of a first type. The determining device 1 allows the gradual deposition of the drops 12 on the surface 11. The image-analyzer 8 processes the received images, identifies the drops and, for each of the drops 12, 16, a ratio is computed between a diameter D1 measured at the base of the drop 16 after its deposition on the surface 11 and a predetermined diameter Dp of the drops 12 (D1/Dp).

The predetermined diameter Dp of a drop 12 is obtained by measuring, in a laboratory, the diameter of a drop 12 released from a nozzle 10 of a print head 6 of a first type, and before the drop 12 touches a surface 11.

A ratio is obtained for each drop 12, 16 of the set, and this ratio is compared with a predetermined threshold.

The predetermined threshold is dependent on the surface 11 (roughness, wettability, etc.), on the volume of the drops released by the nozzles 10, on the fluid used for the drops 12 and on the value of the contact angle of the drops 16 chosen by the operators to determine whether a drop is situated on a contaminated or uncontaminated surface.

For example, this threshold could be computed by virtue of the following formula:

$$r = \frac{3}{π} \sqrt[3]{\frac{v}{( 2 * cos ( θ ) ) {( 1 - cos ( θ ) )}^{2}}}$$

$$h = r ( 1 - cos ( θ ) )$$

$$d = 2 \sqrt{h ( 2 r - h )}$$

θ=contact angle of the drop 16
V=Volume of the drop 12, 16
r=radius of the drop 12, 16
d=diameter of the drop 12, 16
h=height of the drop 12, 16

With reference to FIG. 2, in the example of a drop volume substantially equal to 100 μl, and for the choice of a contact angle smaller than 30° considered to be an angle value below which the surface under the drop 16 is said to be uncontaminated, the predetermined threshold is equal to 2. The ratio (D1/Dp) therefore has to be greater than or equal to 2 for the surface under the drop 16 to be considered to be uncontaminated. With these hypotheses, the diameter D1 and the diameter Dp have been computed according to the preceding formulations. The ratio (D1/Dp) is equal to 2.068, and this implies an uncontaminated surface under the drop 16.

Conversely, if the ratio (D1/Dp) is less than 2, the surface situated under the drops 16 is considered to be contaminated.

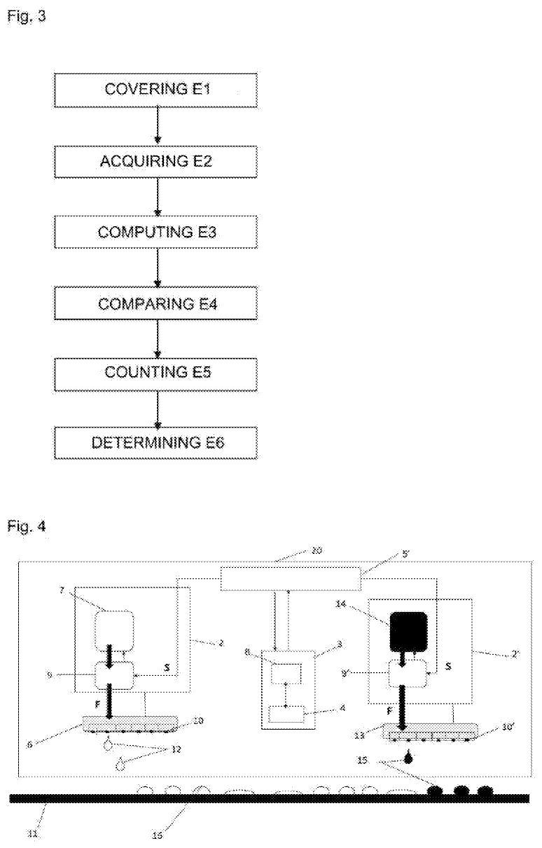

With reference to FIG. 3, the device 1 for determining a level of contamination of a surface 11 implements the following method. To this end, the device 1 is moved closer to the surface 11 to be analyzed, with the orifices of the nozzles 10 oriented towards the surface.

In a preliminary preparing step E0, not shown, the operator acting on the central unit 5 triggers the capture, by the optical system 3, of an image of the surface 11 to be analyzed. The central unit 5 comprises software that displays the image thus captured, allowing the operator to choose the part or parts of the surface 11 to be treated by the device 1 for determining a level of contamination of a surface 11. In this preliminary preparing step E0, the operators indicate the predetermined threshold to be taken into account in the following steps of the method. The operators have, for example, reference tables indicating, for each type of surface, the predetermined threshold to be input into the central unit 5.

In the remainder of the method, the operator is considered to have chosen to treat the entire surface.

In a covering step E1, consecutive to the preparing step E0, the surface 11 of which the level of contamination is to be evaluated is covered with drops of colorless fluid 16 deposited according to a deposition scheme. This scheme is defined by the central unit 5 depending on the configuration of the surface, i.e. its dimensions, and so as to meet the following constraints:
the distance between two successively deposited drops of colorless fluid 16 is substantially constant, each drop of colorless fluid 16 is spaced apart by a non-zero distance from the other drops 16 of colorless fluid surrounding it.

In an acquiring step E2, subsequent to the covering step E1, the optical system 3 described above acquires the image of the surface 11 to be analyzed covered with the deposited drops of colorless fluid 16 and measures the diameters at the base of the drops 16. The measurement taken at the base of the drops depends on the rate of advance of the device 1 for determining the level of contamination of a surface 11. It will also be recalled that the diameter at the base of a drop 16 on the surface 11 depends on the presence or absence of contamination under the drop 16.

In a computing step E3, subsequent to the acquiring step E2, and for each of the drops 12, 16, the optical system 3 computes the ratio between the diameter D1 measured at the base of the drop 16 and the predetermined diameter Dp of the drop 12 (D1/Dp).

In a comparing step E4, subsequent to the computing step E3, and for each of the drops 12, 16, the optical system 3 compares the previously computed ratio with the predetermined threshold.

In a counting step E5, subsequent to the comparing step E4, the optical system 3 counts the number of drops 16 of which the ratio is lower than the predetermined threshold and the position of these drops 16 on the surface 11 is recorded, in a memory of the optical system 3.

In a determining step E6, subsequent to the counting step E5, the optical system 3 determines a level of contamination of the surface 11, which depends on the number counted in the preceding counting step and on the total number of drops 16 deposited on the surface 11.

Depositing the drops 12 according to a defined deposition scheme allows exact analysis of the level of contamination of the surface 11.

In a second embodiment, and with reference to FIG. 4, the device 20 for determining a level of contamination of a surface 11 is modified with respect to the device described above in that the device 20 for determining a level of contamination of a surface 11 comprises the addition of at least one print head 13 of a second type and a known print control system associated with the print head 13. The print heads 13 of a second type are in all respects similar to the print head 6 of a first type, except for a cartridge 14 containing a colored ink, instead of the colorless fluid present in the cartridge 7 of the print head 6 of a first type.

The color of the ink is chosen to be different from the color of the surface 11 to be analyzed, in order to optimize the visibility of the ink during the cleaning of the surface 11. Specifically, the colored ink makes it possible to output, in situ, the information concerning the exact location of the contamination to the operator. The ink used is soluble with the solvent used during the cleaning of the contaminated regions of the surface.

With reference to FIG. 5, the method implemented by the device 20 for determining a level of contamination of a surface 11 differs from the method described above in that it comprises an additional step E7 of visually marking the contaminated regions, subsequent to the counting step E5. The visual marking step may take place before or after the determining step E6.

The step E7 of visually marking the contaminated regions is carried out by virtue of the deposition of drops of ink 15 using the print head 13 of a second type and its associated known print control system. The drops of colored ink 15 are deposited in line with the drops of colorless fluid 16 having a ratio lower than the predetermined threshold.

At the end of the method implemented by the device 20 for determining a level of contamination of a surface 11, the visual marking of the contaminated regions by the deposition of the drops of ink 15 allows the operator to quickly see the contaminated regions requiring cleaning. The regions thus marked on the surface 11 are cleaned manually, for example using wipes pre-impregnated with solvent.

This additional step of the method also has the advantage of reducing unnecessary cleaning and of limiting the consumption of resources, such as wipes and solvents, thus contributing to more efficient management of the cleaning operations. In addition, the automation of the detection of the level of contamination of a surface makes it possible to anticipate possible contamination and avoids steps of surface finish renewal, which is detrimental in the context of a production line.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for determining a level of contamination of a surface, the method comprising successive steps of:
covering all or some of the surface with drops of colorless fluid, all having substantially a same volume, the drops being deposited on the surface according to a deposition scheme that is defined depending on a configuration of the surface and wherein:
a distance between two successively deposited drops of colorless fluid is substantially constant; and
each drop of colorless fluid is spaced apart by a non-zero distance from other drops of colorless fluid surrounding it;
acquiring an image of the surface to be analyzed that is covered with drops of colorless fluid;
computing, for each of the drops, a ratio between a diameter and a predetermined diameter of the drops, the diameter being measured at a base of the drop;
comparing, for each drop, a previously computed ratio with a predetermined threshold;
counting, by the optical system, a number of drops for which the surface under the drop is said to be contaminated, and recording a position of these drops on the surface;
determining a level of contamination of the surface, the level being dependent on the number counted and on a total number of drops deposited on the surface.

2. The method according to claim 1, wherein the colorless fluid is purified water.

3. The method according to claim 2, comprising a visual marking step, implemented after the counting step, and in which a print head deposits drops of colored ink, the colored ink being contained in a cartridge, the drops of colored ink being deposited on the surface, at a location of the drops of colorless fluid that have a ratio lower than the predetermined threshold.

4. The method according to claim 3, wherein a color of the ink present in the cartridge is chosen to be different from a color of the surface to be treated.

5. A device for determining a level of contamination of a surface for implementing the method according to claim 1, the device comprising a printing apparatus having at least one print head, an optical system for taking and analyzing an image on the surface, the optical system comprising an image sensor and image-analyzer, a central unit controlling the printing apparatus, wherein each print head comprises a fluid cartridge, pumps, and nozzles of the piezoelectric nozzle type, the actuation of which is controlled by the central unit.
